(19) United States
(12) Patent Application Publication
(10) Pub. No.: US 2009/0193388 A1
(43) Pub. Date: Jul. 30, 2009

(54) SOFTWARE DEVELOPMENT SUPPORT APPARATUS, PROGRAM AND METHOD

(76) Inventors: Shuhei NOJIRI, Ichikawa (JP); Ryota Mibe, Sagamihara (JP); Erika Ayukawa, Tokyo (JP); Sadahiro Ishikawa, Yokohama (JP); Yuji Fukushi, Ichikawa (JP); Kiyoshi Yamaguchi, Kawasaki (JP); Jiro Fukunaga, Kawasaki (JP)

Correspondence Address: BRUNDIDGE & STANGER, P.C., 1700 DIAGONAL ROAD, SUITE 330, ALEXANDRIA, VA, 22314, US

(21) Appl. No.: 12/360,370

(22) Filed: Jan. 27, 2009

(30) Foreign Application Priority Data
Jan. 28, 2008 (JP) 2008-016147

(51) Int. Cl. G06F 9/44

(52) U.S. Cl. 717/101

(57) ABSTRACT

Before design information is published, a consistency state of reference design information referred to by the design information is revealed. By this, it is possible to reduce waste caused by redesign or the like of the design information.

Public design information used for designing the design information is stored as reference design information 210 into a developer design information storage part 202 (S5). When a developer requests publication of the design information that has used the reference design information 210, the design information is stored as public design information 261b into a public design information storage part 260 (S17). When the design information is stored in the public design information storage part 260, a consistency state between reference design information 210 of design information that uses the design information 261b and the design information 261 is verified (S19), and the verified consistency state is stored in a consistency state storage part 203. The consistency state stored in the consistency state storage part 203 is notified to the developer and others.

### BACKGROUND OF THE INVENTION

The present application claims priority from Japanese application serial no. 2008-016147, filed on Jan. 28, 2008, the content of which is hereby incorporated by reference into this application.

The present invention relates to a support technique for developing software that is made by collecting respective pieces of design information of design units.

Large scale software development such as development of a enterprise system requires many participants and produces large amounts of deriverables. Thus, person-to-person relationships, deriverable-to-person relationships, and deriverable-to-deriverable relationships become very complex. To contend with this complexity, large scale software development generally employs a development method called the Waterfall Model.

In the Waterfall Model, first a development project is divided into processes or steps. When, design work in a process is finished, fully examined and approved, then design work in the next process is carried out. Further, the project is proceeded in such a way that design work in each process uses design deriverables of the upper processes and delivers the produced deriverables to the lower processes. By doing this, it is possible to clarify a flow of deriverables and make the management of progress easy.

In practice, however, it is rare that all pieces of design information are collected before proceeding to the next process. Further, it is also rare that there is no need to redo an upper process. Three reasons can be mentioned as main reasons for these.

1. Delay becomes too long if downstream work is started after complete collection of upstream deriverables.
2. Particularly in the case of an enterprise system, change of requirements occurs very often, and such change leads to change in specifications.
3. It is unrealistic that design is made without error. Thus, change in specifications can not be avoided to take care of bugs.

Since, as described above, deriverables are large in number and complex, one deriverable relates to many deriverables. Thus, when specifications are to be changed, it is difficult to investigate deriverables related to the specification change and to reveal manually deriverables that are likely to be changed.

As techniques for supporting this work systematically, the techniques described in the following Patent Documents 1 and 2 can be mentioned, for example.

According to the technique described in the Patent Document 1 (Japanese Unexamined Patent Application Laid-Open No. 5-35460), relationships between published deriverables are acquired and managed. When there is a change in some deriverable, information on deriverables that are likely to be changed is provided by notifying the related deriverables to developers, for example by setting the flag on those deriverables.

Further, according to the technique described in the Patent Document 2 (Japanese Unexamined Patent Application Laid-Open No. 2006-79212), common parts of a plurality of published deriverables are extracted and managed in a unified manner. When there is a change in some deriverable, the unifiedly-managed common parts are overwritten to reflect the change automatically and support reflection of the specification change.

### SUMMARY OF THE INVENTION

The above-described conventional techniques have the following problems.

In each of the techniques described in the Patent Documents 1 and 2, when a specification change occurs and a developer affected by the specification change does not acquire again the design information relating to the specification change, the other developers and the manager will know that fact only after the developer in question registers his deriverables in a repository. Here, the repository means a database used for storing design deriverables in software development. Design deriverables can be published to the other developers by storing the design deriverables in a repository, and then the other developers can freely access the design deriverables.

In large scale development, it is difficult to ensure that a developer's design tool is always coupled with a repository for physical reasons such as dispersion of development bases in a plurality of locations or restriction on use of network. Further, even when a developer is informed of a specification change from the repository by E-mail or the like, the developer frequently wishes to complete design on which he is working now before he deals with the specification change. Thus, sometimes the developer does not immediately take in the changed deriverables to his design tool, and as a result he forgets to deal with the changed deriverables. Further, sometimes upper deriverables held in the design tool may be out of line with the published deriverables for reasons on the side of the developer such as developer's overlooking of a notification itself in the first place. Since the number of developers is large in large scale development, it is highly possible that such a situation occurs.

In such a case, according to the techniques described in the Patent Documents 1 and 2, the necessity of redesign becomes revealed only when a developer examines consistency in pieces of design information (deriverables) after publication of the design information or registration of the design deriverables in the repository. In this case, the following problems occur. (1) The amount of time developers worked without referring to the latest design information goes to waste. (2) The amount of working time of other developers who will be affected by redesign goes to waste. In particular, as regards the problem (2), the larger the scale of development is, the broader the extent of impact becomes. And, the later the necessity of redesign is revealed, the more man-months are used wastefully, causing delay of delivery date.

Thus, an object of the present invention is to improve development efficiency by reducing waste caused by redesign of design information or the like.

To solve the above problems, the present invention is characterized in that:

pieces of design information developed by a developer are stored as respective pieces of public design information into a first storage area of the computer;

the public design information used by a developer for designing design information is acquired from the first storage area, and the acquired public design information is provided as reference design information to the developer;

pieces of public design information used by a developer for designing design information among the pieces of public design information are stored as reference design information into a second storage area of the computer;

when the design information is stored in the first storage area as the public design information, a consistency state between the public design information and reference design information referring to the public design information among the pieces of reference design information stored in the second storage area, and the verified consistency state is stored as a first consistency state into a third storage area of the computer; and

development status information including information of the consistency state stored in the third storage area is notified to an outside.

According to the present invention, when design information is published as public design information, a consistency state between the public design information and reference design information referring to the public design information is verified. This consistency state is notified to a developer or the like even before development design information that has used the reference design information is published. As a result, it is possible to reduce waste owing to redesign or the like of the development design information, and efficiency of the development can be improved.

These and other features, objects and advantages of the present invention will become more apparent from the following description when taken in conjunction with the accompanying drawings wherein:

### BRIEF DESCRIPTION OF THE DRAWINGS

FIG. 1 is a diagram showing a configuration of a software development support apparatus of an embodiment according to the present invention;

FIG. 2 is a functional block diagram relating to processing performed by a software development support apparatus of an embodiment of the present invention, i.e. processing of a design information acquisition request;

FIG. 3 is a functional block diagram relating to processing performed by a software development support apparatus of an embodiment of the present invention, i.e. processing of a design information storage request;

FIG. 4 is an explanatory diagram showing a data structure of public design information of data item definition in an embodiment of the present invention;

FIG. 5 is an explanatory diagram showing a data structure of public design information of interface definition in an embodiment of the present invention;

FIG. 6 is an explanatory diagram showing a data structure of developer design information in an embodiment of the present invention;

FIG. 7 is an explanatory diagram showing a data structure of reference design information in an embodiment of the present invention;

FIG. 8 is an explanatory diagram showing a data structure of developer's design information in an embodiment of the present invention;

FIG. 9 is an explanatory diagram showing a data structure of storage reference consistency information (before update) in an embodiment of the present invention;

FIG. 10 is an explanatory diagram showing a data structure of storage reference consistency information (after update) in an embodiment of the present invention;

FIG. 11 is an explanatory diagram showing a data structure of intra-information reference consistency information in an embodiment of the present invention;

FIG. 12 is an explanatory diagram showing a data structure of related information in an embodiment of the present invention;

FIG. 13 is an explanatory diagram showing a data structure of reference consistency information classified by developer in an embodiment of the present invention;

FIG. 14 is an explanatory diagram showing a data structure of reference consistency information classified by development process in an embodiment of the present invention;

FIG. 15 is an explanatory diagram showing a data structure of estimated development progress status classified by development process in an embodiment of the present invention;

FIG. 16 is a flowchart (first part) showing operation of a software development support apparatus in an embodiment of the present invention;

FIG. 17 is a flowchart (second part) showing operation of a software development support apparatus in an embodiment of the present invention;

FIG. 18 is a flowchart (third part) showing operation of a software development support apparatus in an embodiment of the present invention;

FIG. 19 is a flowchart (first part) showing detailed processing of the step 19 of the flowchart shown in FIG. 17;

FIG. 20 is a flowchart (second part) showing detailed processing of the step 19 of the flowchart shown in FIG. 17;

FIG. 21 is a flowchart showing detailed processing for acquiring estimated development status in the step 25 of the flowchart shown in FIG. 18;

FIG. 22 is an explanatory diagram showing a rule used for acquiring estimated development status in an embodiment of the present invention;

FIG. 23 is an explanatory diagram showing a check-in state and a check-out state in an embodiment of the present invention; and

FIG. 24 is an explanatory diagram showing conceptually main contents of processing by a software development support apparatus in an embodiment of the present invention.

### DESCRIPTION OF THE EMBODIMENTS

Now, an embodiment of a software development support apparatus of the present invention will be described referring to the drawings.

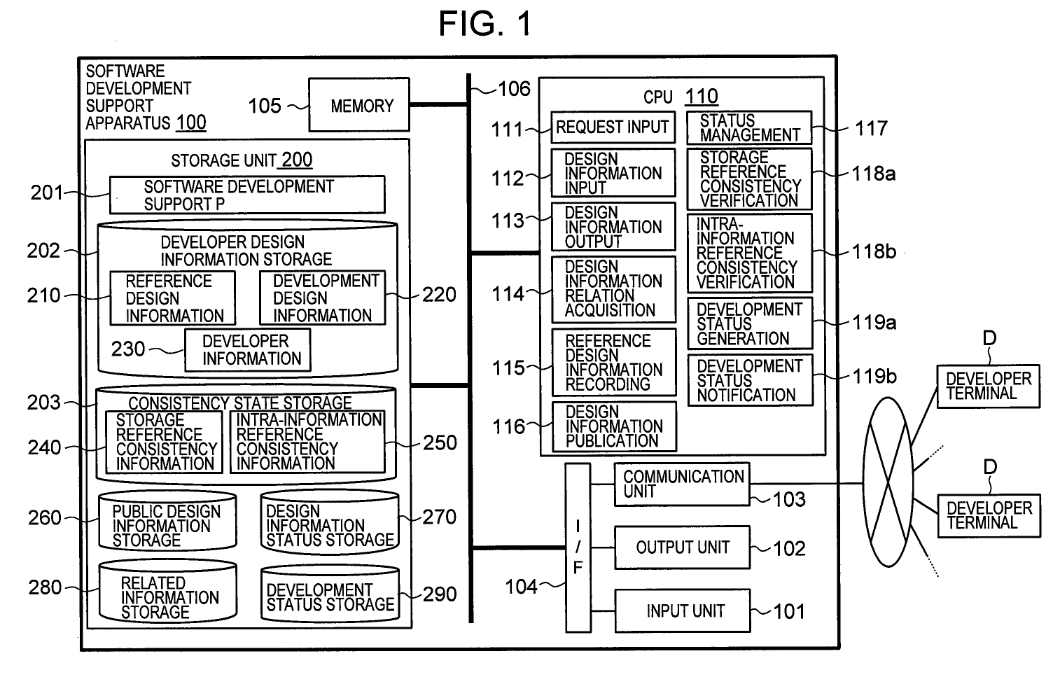

As shown in FIG. 1, the software development support apparatus 100 of the present embodiment is coupled with a developer terminal D of each developer via a network.

The software development support apparatus 100 is a computer, and comprises: an input unit 101 such as a keyboard and/or a mouse; an output unit 102 such as a display, a printer or the like; a communication unit 103 for communicating with other apparatuses; an interface 104 for the mentioned component units; a CPU 110 for executing various processing; a memory 105 as a work area for the CPU 110; a storage unit 200 such as a hard disk drive; and a bus 106 coupling these components with one another.

The storage unit 200 comprises: a software development support program 201; a developer design information storage part 202 for storing information that a developer of a software needs at the time of development; a consistency state storage part 203 for storing consistency states of various pieces of information; a public design information storage part 260 for storing, as public design information (deriverables), design information that is produced by a developer and completed for the time being design; a design information status storage part 270 for storing a status of public design information; a related information storage part 280 for storing related information concerning reference between pieces of design information; and a development status storage part 290.

The developer design information storage part 202 stores: reference design information 210 used for designing by a developer; development design information 220 on design that is actually being made by a developer; and developer information 230 for specifying a developer as well as processes and the like whose design is dealt with by that developer. Reference design information 210 is a piece of public design information used as reference design information by a developer, among the public design information stored in the public design information storage part 260. The piece of public design information in question is added with various kinds of management information. Each of the reference design information 210, the development design information 220 and the developer information 230 exists for each developer, and will be described in detail later.

The consistency state storage part 203 stores: storage reference consistency information 240 indicating whether reference design information 210 stored in the developer design information storage part 202 is consistent with public design information; and intra-design-information reference consistency information 250 indicating whether reference design information in development design information (published or unpublished) is consistent with the referred design information (published or unpublished). The storage reference consistency information 240 and the intra-design-information reference consistency information 250 also will be described in detail later.

From the functional viewpoint, the CPU 110 comprises: a request input part 111 that receives various requests from developers; a design information input part 112 that receives design information; a design information output part 113 that outputs design information; a design information relation acquisition part 114 that acquires related information between pieces of design information; a reference design information recording part 115 that stores reference design information 210 into the developer design information storage part 202, wherein the reference design information 210 is some of the pieces of public information stored in the public information storage part 260; a design information publication part 116 that stores public design information into the public design information storage part 260, wherein the public design information is pieces of design information whose publication has been requested among the pieces of design information received by the design information input part 112; a status management part 117 that manages statuses of the public design information stored in the public information storage part 260; a storage reference consistency verification part 118a that verifies whether the reference design information 210 stored in the developer design information storage part 202 is consistent with the public design information; an intra-design-information reference consistency verification part 118b that verifies whether the reference design information in the development design information (published or unpublished) is consistent with the referred design information (published or unpublished); a development status generation part 119a that generates development status information; and a development status notification part 119b that notifies a requester of the development status information. Here, each of these functional parts 111-119b functions when the CPU 110 executes the software development support program 201.

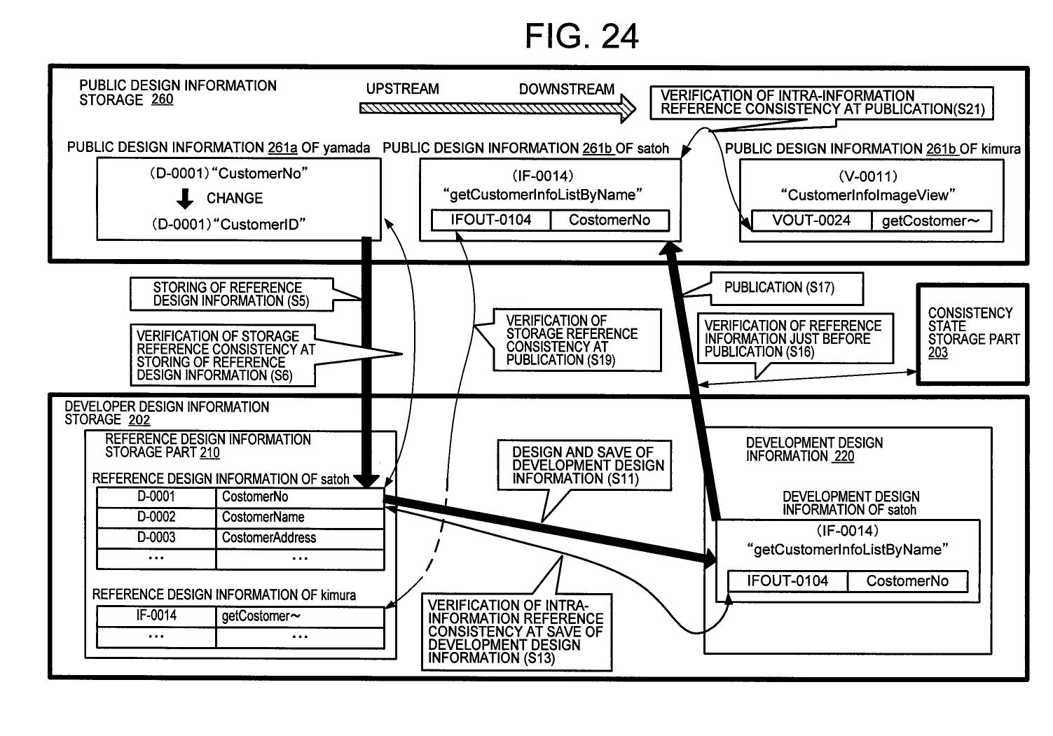

Next, referring to the conceptual diagram shown in FIG. 24, an outline of a software development support method in the present embodiment will be described.

Here, it is assumed that “satoh” is in charge of an “interface definition” process, and he designs an interface definition “getCustomerInfoListByName” by using public design information “CustomerNo” 261a of “yamada” in the public design information storage part 260 as reference design information. Further, it is assumed that “kimura” is in charge of an “image view definition” process, and he designs an image view definition “CustomerInfoImageView” by using public design information “getCustomerInfoListByName” 261b of “satoh” in the public design information storage part 260 as reference design information. That is to say, here, the design information “CustomerNo” of “yamada” is the uppermost design information, and the design information “getCustomerInfoListByName” of “satoh” is its lower design information, and the design information “CustomerInfoImageView” of “kimura” is the lowermost design information.

First, in response to a request from the developer “satoh”, the software development support apparatus 100 provides the public design information “CustomerNo” 261a of “yamada” in the public design information storage part 260 as reference design information to the developer “satoh”. Here, the public design information “CustomerNo” 261a is to be used for designing the interface definition “getCustomerInfoListByName”. Further, the software development support apparatus 100 stores the public design information “CustomerNo” 261a as reference design information 210 into the developer design information storage part 202 (S5).

The developer “satoh” designs the interface definition “getCustomerInfoListByName” by using the reference design information “Customer No” provided from the software development support apparatus 100. When the software development support apparatus 100 receives a request for saving the interface definition “getCustomerInfoListByName” from the developer “satoh”, the software development support apparatus 100 saves the definition in the developer design information storage part 202 as development design information (S11).

After that, when the software development support apparatus 100 receives a request for publishing the interface definition “getCustomerInfoListByName” from the developer “satoh”, the software development support apparatus 100 verifies consistency information stored in the consistency state storage part 203 (S16). When the consistency information is “consistent”, the software development support apparatus 100 publishes the design information in question as public design information 261b (S17). In other words, the software development support apparatus 100 stores the interface definition “getCustomerInfoListByName” as the public design information 261b in the public design information storage part 260 so that other developers can use it.

Also in the case where the developer “kimura” designs the image view definition “CustomerInfoImageView”, the software development support apparatus 100 stores the public design information “getCustomerInfoListByName” 261b as reference design information 210 into the developer design information storage part 202 similarly to the above (S5). And, the software development support apparatus 100 saves the image view definition “CustomerInfoImageView” designed by using this in the developer design information storage part 202 as development design information 220 (S11). Further, when the software development support apparatus 100 receives a request for publishing the image view definition “CustomerInfoImageView” from the developer “kimura”, the software development support apparatus 100 verifies consistency information (S16), and thereafter publishes the design information in question as public design information 261c (S17).

In passing, in actual software development, the public design information “CustomerNo” 261a of “yamada”, which is referred to by the developer “satoh”, is often changed to “CustomerID” before or after the developer “satoh” publishes the interface definition “getCustomerInfoListByName”. Change of the uppermost design information “CustomerNo” affects not only the lower design information “getCustomerInfoListByName” of “satoh” but also the much lower design information “CustomerInfoImageView” of “kimura”.

As described in the Background of the Invention, there may occur a situation where the reference design information held in a developer terminal is out of line with the public design information stored in the public design information storage part 260 because of restriction of the network, the main subject of the developer himself, or the like. In such a case, according to the techniques of the Patent Documents 1 and 2, it will be revealed only after publication of the design information that inconsistency lies in the design information and redesign is needed. This causes a problem such that revelation of the need for redesign is delayed.

In the present embodiment, the design information “getCustomerInfoListByName” that is referred to by the developer “kimura” is not only provided to the developer “kimura”, but also stored as the reference design information 210 in the developer design information storage part 202. The development design information “CustomerInfoImageView” is designed by using the reference design information in question. When the upper development design information (i.e. the development design information “getCustomerInfoListByName” as the origin of the reference design information) to the development design information “CustomerInfoImageView” is published as the public design information 261b (S17) even if the development design information “CustomerInfoImageView” is not published, then consistency is verified between the public design information 261b and the reference design information “getCustomerInfoListByName” 210 of the development design information that refers to the public design information 261b (S19). The verified consistency state is notified to the developer “kimura” and others.

Further, in the present embodiment, when the design information “getCustomerInfoListByName” is saved as the development design information 220 in the developer design information storage part 202 (S11), the consistency state is verified between the reference design information “CustomerNo” included in the development design information “getCustomerInfoListByName” and “CustomerNo” stored as the reference design information 210 in the developer design information storage part 202 (S13), and this consistency state is notified to the developers. Further, in the present embodiment, when the development design information “getCustomerInfoListByName” is modified and thereafter published as the public design information 261b again (S17), and if the design information “CustomerInfoImageView 261c” that refers to the public design information 261b in question is already published, then consistency between the newly-published public design information “getCustomerInfoListByName” 261b and the reference design information “getCustomerInfoListByName” included in the already-published lower-side public design information “CustomerInfoImageView” 261c is verified (S21), and this consistency state also is notified to the developers.

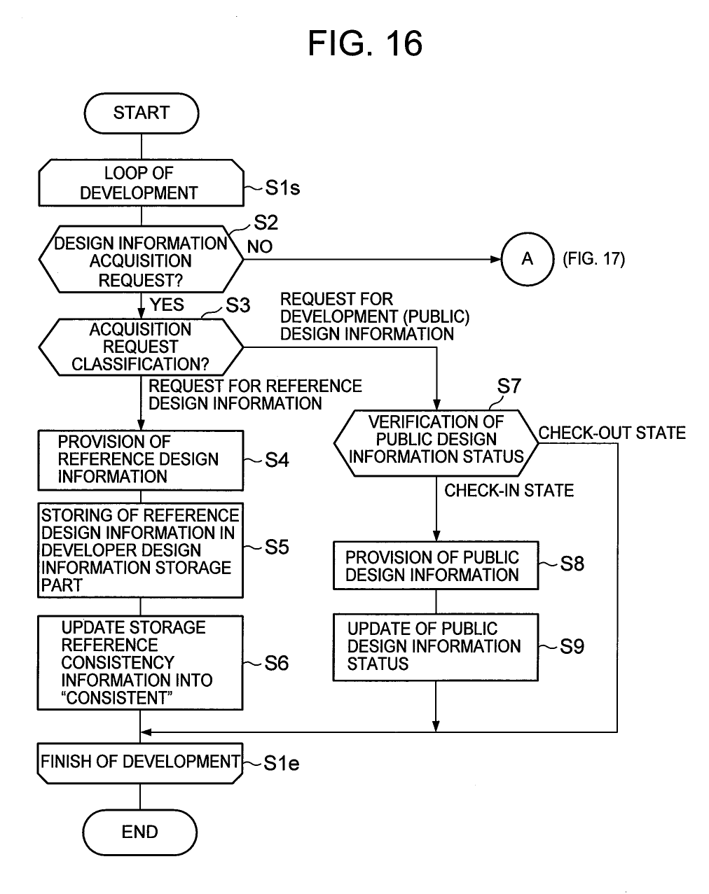

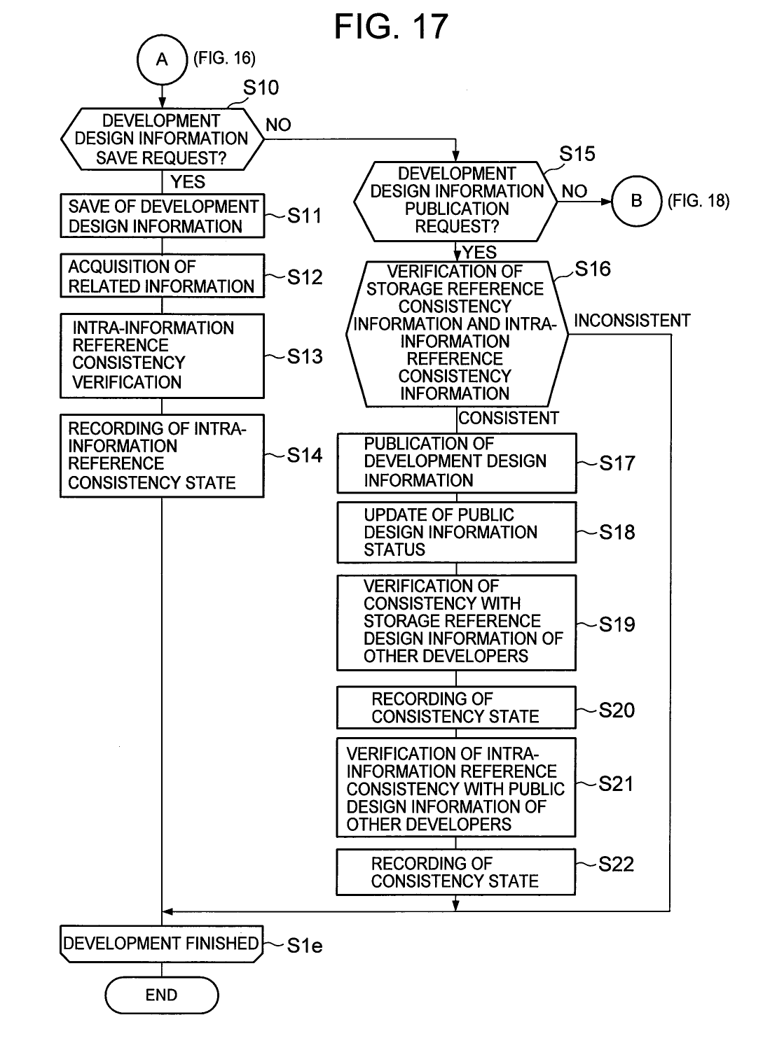

Next, referring to the flowcharts shown in FIGS. 16-21, operation of the software development support apparatus 100 of the present embodiment will be described.

As shown in FIG. 16, the step 1 is a loop meaning that the software development support apparatus 100 operates while software development continues. This is a state of waiting for a request from a developer or the manager. A finish of the development causes exit from the loop, to end the development. If there is a request concerning the development from a developer or the manager (i.e. if the development should be continued), then the flow proceeds to the step 2.

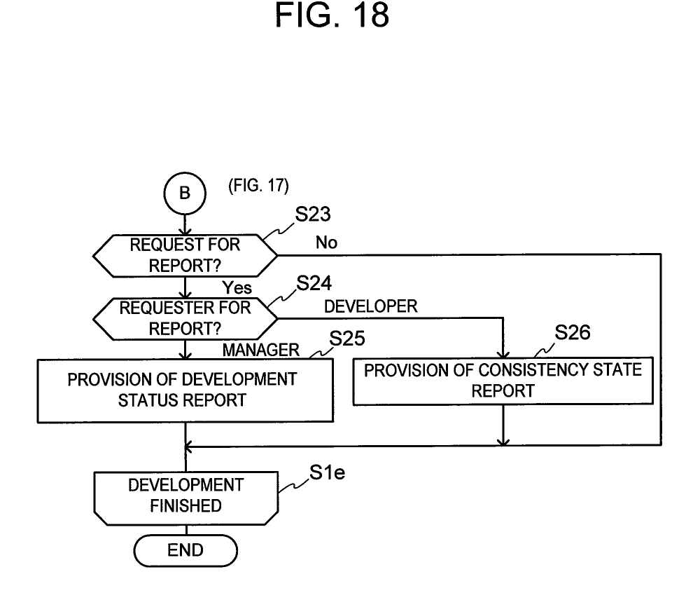

The step 2 is a process in which the request input part 111 judges whether the request from the developer or the manager is a request to acquire design information. If it is a request to acquire design information, the flow proceeds to the step 3. Otherwise, the flow proceeds to the step 10 (FIG. 17).

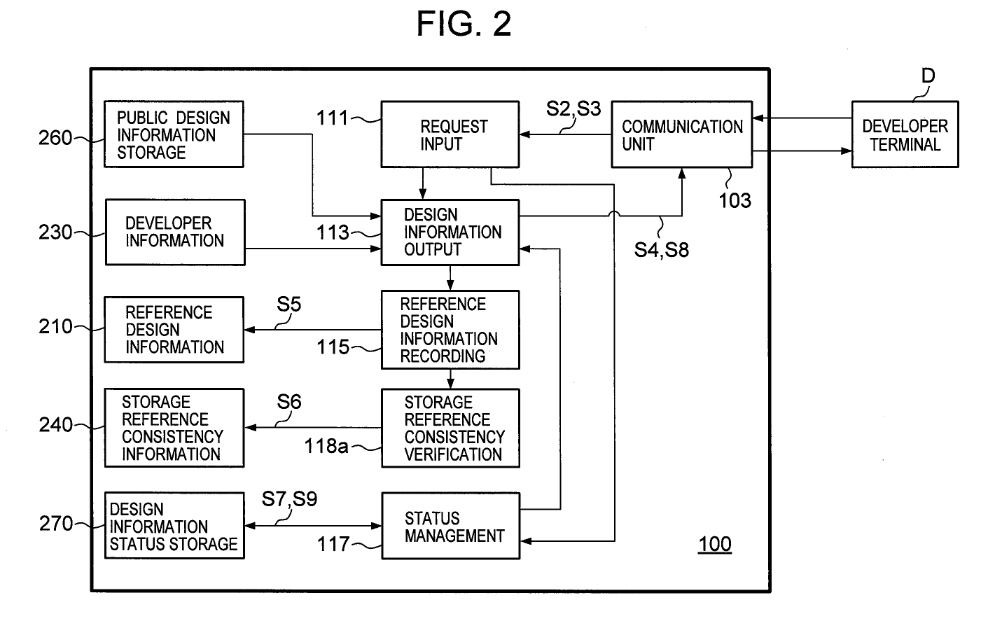

Then, the steps 3-9 are processes responding to the design information acquisition request, and executed by the functional parts 111, 113, 115, 117 and 118a shown in FIG. 2.

The step 3 is a process in which the request input part 111 judges the classification of the design information acquisition request. If the classification of the design information acquisition request is a request to acquire reference design information that is referred to at the time of design, the flow proceeds to the step 4. On the other hand, if the classification of the design information acquisition request is a request to acquire development design information of design that is to be started now, then the flow proceeds to the step 7.

The steps 4-6 described in the following are processes responding to the request to acquire reference design information.

The step 4 is a process in which the design information output part 113 provides the reference design information to the developer. Based on the developer information 230, the design information output part 113 takes out a list of public design information referred to by the developer from the public design information storage part 260. Then, the design information output part 113 outputs the acquired public design information as reference design information to the developer terminal D or the output unit 102.

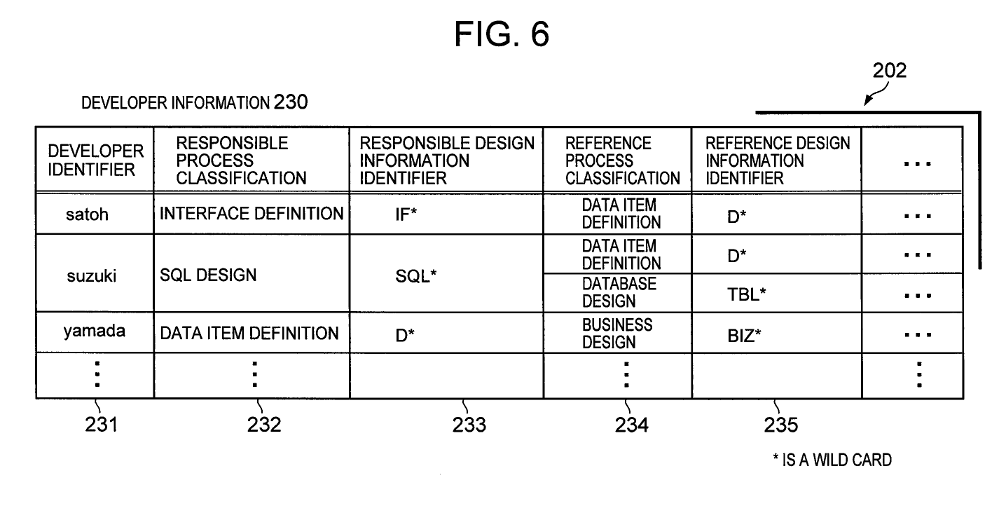

Here, as shown in FIG. 6, the developer information 230 is information that includes: a developer identifier 231 for indicating the developer concerned; a responsible process classification 232 indicating the process of which the developer is in charge; a responsible design information identifier 233 for indicating a responsible design information in the responsible process; a reference process classification 234 indicating a process of designing reference design information used by the developer in question for his designing; and a reference design information identifier 235. Here, each of the responsible design information identifier 233 and the reference design information identifier 235 does not indicate design information itself, but is only a wild card. Further, the developer information 230 is information determined in a planning stage and set out before the software development support apparatus 100 actually supports the development.

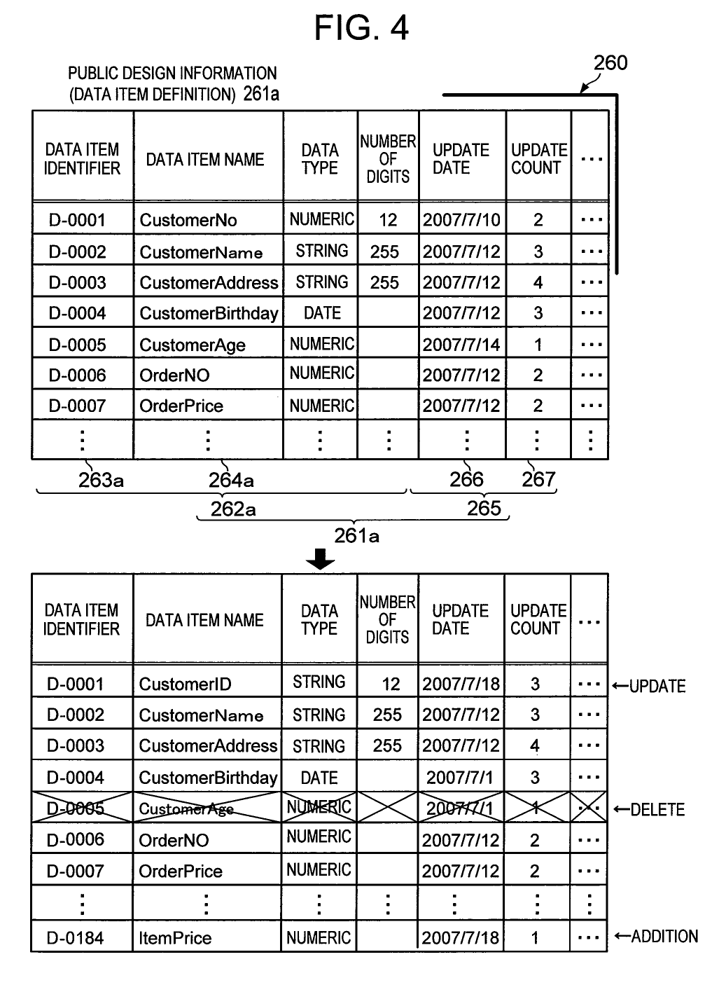

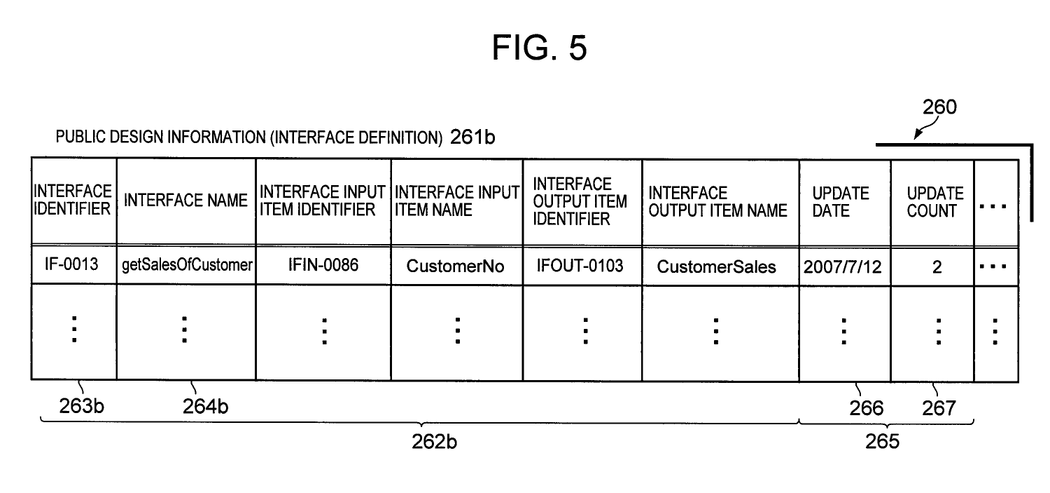

The public design information storage part 260 is a database in which design information that is produced by a developer and completed for the time being is stored as public design information (deriverable). Thus, the public design information storage part 260 is a repository. As shown in FIGS. 4 and 5, the public design information 261a and 261b stored in this repository is information that includes: design main body information 262a, 262b; and management information 265 for the design main body information 262a, 262b. The design main body information 262a, 262b includes: an identifier of the design information (a data item identifier or an interface identifier) 263a, 263b; a design information name (a data item name and an interface name) 264a, 264 b, and various pieces of data. Further, the management information 265 includes an update date 266 indicating the date on which the design main body information 262a, 262b was updated; and an update count 267 indicating how many times the design information 262a, 262b has been updated since its registration. FIG. 4 shows the public design information 261a in the case where the design process concerned is data item definition, while FIG. 5 shows the public design information 261b in the case where the design process concerned is interface definition. As seen from these figures, various pieces of data in design main body information 262a, 262b differ in contents of data species and the number of the data species if the process or the like as the object of design differs.

Further, in the present embodiment, design information means a smallest design unit, which will not make sense if it is divided. Thus, design information is one record of information in FIGS. 4 and 5. Or, in other words, design information is information formed by integrating data of the items of one record of FIG. 4 or 5.

For example, if the developer having the identifier “satoh” requests acquisition of reference design information in this step 4, the design information output part 113 refers to the developer information 230 (FIG. 6) and grasps the reference process classification “Data item definition” 234 and the reference design information identifier “D” 235 from the record whose developer identifier 231 is “satoh”. Then, the design information output part 113 acquires all pieces of public design information corresponding to it (i.e. all pieces of public design information having the data item identifier “D” in FIG. 4) from the public design information storage part 260. Then, the design information output part 113 provides each of these pieces of public design information as a reference design information to the developer.

The step 5 is a process in which the reference design information storage part 115 stores reference design information into the developer design information storage part 202. The reference design information storage part 115 acquires the public design information that the design information output part 113 provides to the developer in the step 4, and stores the acquired public design information as the reference design information 210 of the developer in question into the developer design information storage part 202.

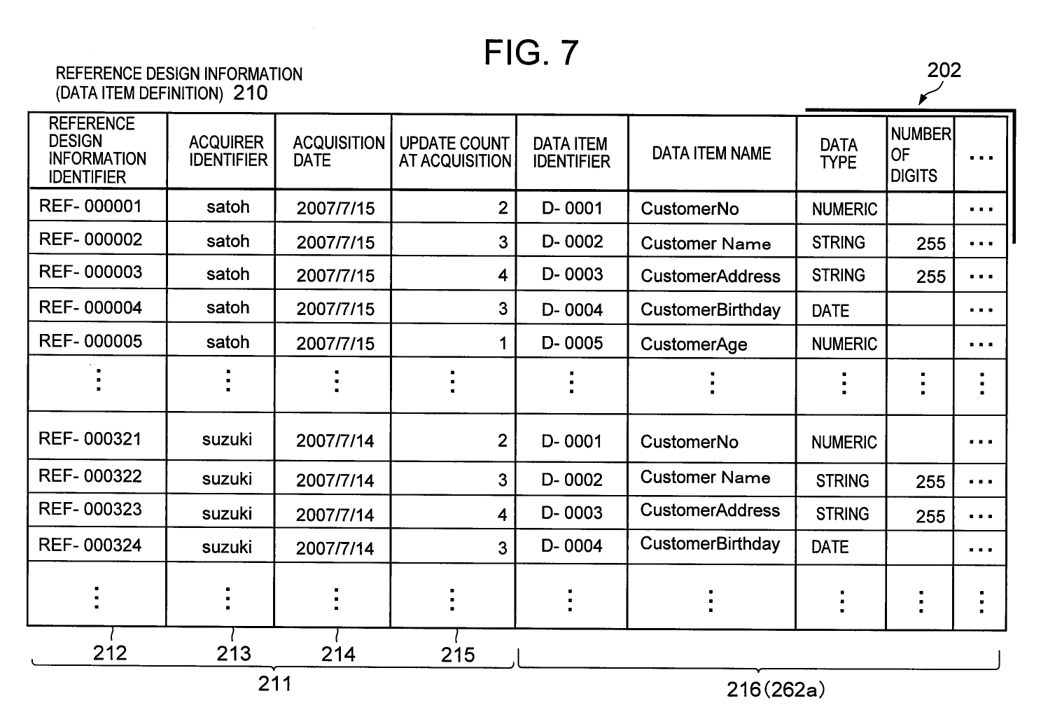

As shown in FIG. 7, the reference design information 210 includes design main body information 216 and management information 211 for the design main body information 216. The design main body information 216 is the design main body information 262a in the public design information 261a that the design information output part 113 provided as the reference design information to the developer in the step 4. Further, the management information 211 includes: a reference design information identifier 212; an acquirer identifier 213 i.e. the identifier of the developer who acquired the reference design information in the step 4; an acquisition date 214 i.e. the date when the reference design information was provided; and an update count at acquisition 215 i.e. the update count at the time of acquisition of the reference design information. Here, the update count at the time of acquisition 215 is the update count 267 (FIG. 4) in the public design information 261a at the time when the developer acquired the public design information as the reference design information.

For example, if the public design information 261a (FIG. 4) was provided as reference design information to the developer having the identifier “satoh” in response to a request to acquire reference design information by the developer in the step 4 as described above, then each of all records having “satoh” as the acquirer identifier 213 is stored as reference design information 210 in the developer design information storage part 202 as shown in FIG. 7.

The step 6 is a process in which the storage reference consistency verification part 118a records the consistency state of the reference design information stored in the step 5. Here, the newest reference design information has just been provided to the developer, and thus the state “consistent” is recorded as the consistency state of the reference design information in relation to the public design information that is the origin of the reference design information.

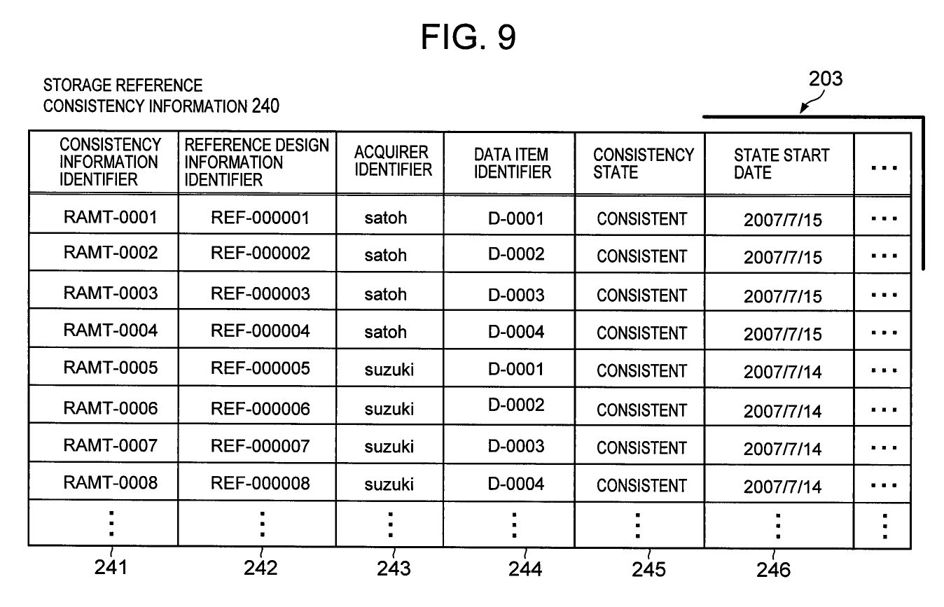

As shown in FIG. 9, the storage reference consistency information 240 of the developer who has received the reference design information includes: a reference consistency information identifier 241 i.e. an identifier that specifies the storage reference consistency information 240 uniquely; a reference design information identifier 242 i.e. an identifier of reference design information acquired by a developer; an acquirer identifier 243 i.e. an identifier of the developer who acquired the reference design information; a design information (data item) identifier 244 i.e. an identifier of the reference design information; a consistency state 245 of the reference design information in relation to the public design information; and a state start date 246 i.e. the date of start of the state in question. For example, as for information whose acquirer identification 243 is “satoh”, the consistency states 245 of all pieces of reference design information that “satoh” acquired in the step 4 are recorded as “consistent” in this step 6.

With that, the processing of acquiring the reference design information is ended, and the flow returns to the step 1.

In the present embodiment, the reference design information provided to the developer in the step 3 is saved in the step 5. By this arrangement, it is possible to detect early a possibility of occurrence of inconsistency in the reference design information or the design information produced by using the reference design information, before the developer publishes the design information produced by using the reference design information. As a result, it becomes possible to notify the newest consistency state to the developer or the manager before publication of the design information. Also, it becomes possible to provide a progress status of the developer in detail. Details of a method of notifying the progress status will be described later.

As described above, if it is judged in the step 3 that the classification of the design information acquisition request is a request to acquire development design information, the flow proceeds to the step 7. The steps 7-9 described in the following are processes responding to a request to acquire development design information.

The step 7 is a process in which the status management part 117 refers to the design information status storage part 270 to verify the status of development design information. As shown in FIG. 23, the status of development design information is a check-in state in which editing of the development design information is finished for the time being and the development design information is published as public design information or a check-out state in which the development design information is in the course of editing. The check-out state is an exclusive state with respect to editing of the development design information, and the other developers can not edit the development design information until the development design information is in the check-in state. If the status of the development design information is already the check-out state (i.e. the information is in the course of editing), the development design information can not be acquired. Thus, the request to acquire the development design information is rejected, and the flow returns to the step 1. On the other hand, if the status of the development design information is the check-in state (i.e. the information is now public), the flow proceeds to the step 8.

The step 8 is a process in which the design information output part 113 provides the development (public) design information. The design information output part 113 takes out the design information requested by the developer from the public design information storage part 260, and outputs the acquired public design information as development design information to the developer terminal D or the output unit 102. At that time, the design information output part 113 may examine whether the developer is trying to acquire development design information as for design information of a process that is not in his charge.

The step 9 is a process in which the status management part 117 updates the status of the public design information. Since the public design information was provided as the development design information to the developer in the step 8, the status management part 117 writes into the design information status storage part 270 the fact that the public design information has been in the check-out state so that the public design information is treated as the design information in the course of editing.

The step 9 finishes the processing concerning the request to acquire the development design information, and the flow returns to the step 1.

As described above, if it is judged in the step 2 that the request from the developer or the manager is not a request to acquire design information, the flow proceeds to the step 10 (FIG. 17).

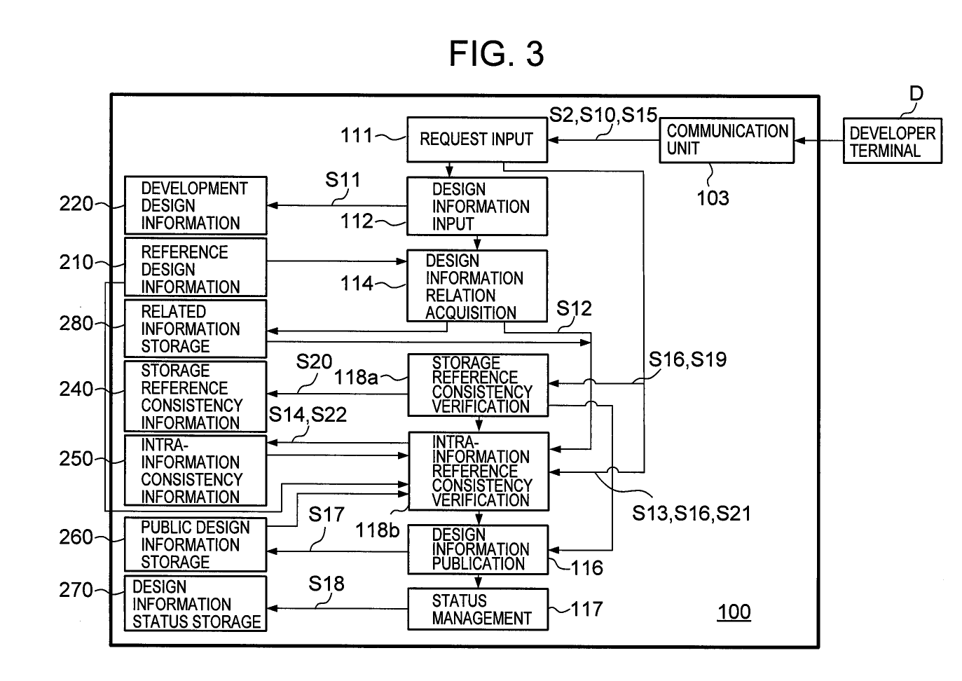

In the flowchart of FIG. 17, the steps 10-22 described in the following are processes responding to a request for saving the development design information, and the processes are executed by the functional parts 111, 112, 114, 116, 117, 118a and 118b shown in FIG. 3.

The step 10 is a process in which the request input part 111 judges whether the request from the developer or the manager is a request for saving development design information or not. If it is a request for saving development design information, the flow proceeds to the step 11. Otherwise, the flow proceeds to the step 15.

The steps 11-14 described in the following are processes responding to the request for saving the development design information.

The step 11 is a process in which the design information input part 112 saves the development design information received from the developer or the like. The design information input part 112 receives the development design information from the developer terminal D through the communication unit 103 and the request input 111, and saves the received information as the development design information 220 of the developer in question into the developer design information storage part 202. In some cases, the development design information is received from the developer or the like through the input unit 101.

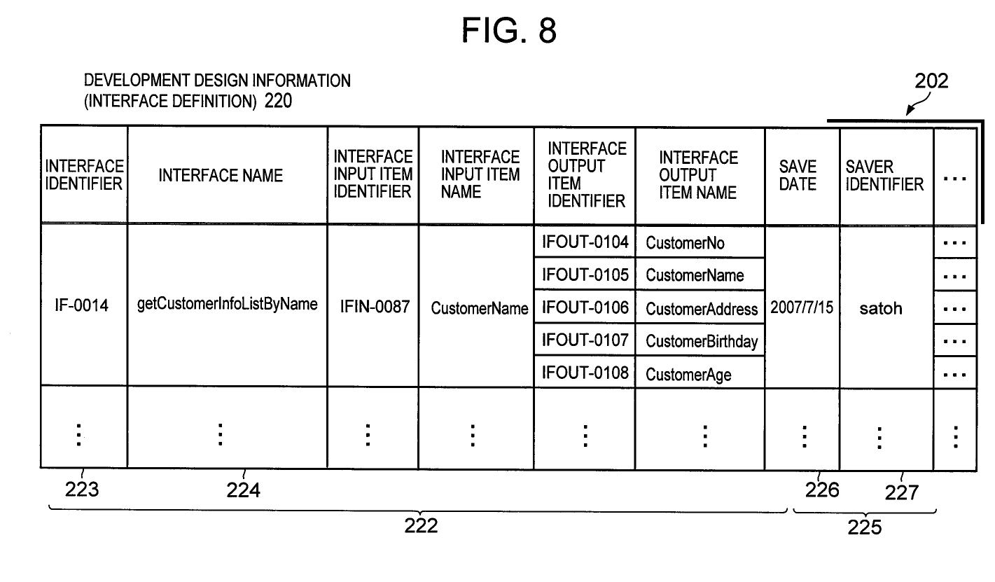

As shown in FIG. 8, the development design information 220 saved in the developer design information storage part 202 includes development design main body information 222 and management information 225 for the main body information 222. In the case where the process classification concerning the development design information 220 is “interface definition”, the development design main body information 222 includes: an interface identifier 223 i.e. an identifier of the design information; an interface name 224 as the name of the design information; and various pieces of data. Further, the management information 225 includes: a date 226 on which the development design information 220 in question was saved; and a saver identifier 227 for identifying the person who saved the development design information. If the interface identifier 223 as the identifier of the design information has not been set at the time of receiving the development design information, the design information input part 112 sets the interface identifier 223. FIG. 8 shows an example that the developer “satoh” has designed a new interface definition “getCustomerInfoListByName”, and saved it.

The step 12 is a process in which the design information relation acquisition part 114 acquires related information. When the design information input part 112 saves the development design information 220 in the step 11, the design information input part 112 calls the design information relation acquisition part 114. The design information relation acquisition part 114 acquires a relation of data of each item in the development design information 220 saved in the step 11 to reference design information of the development design information 220, and writes the acquired relation in the related information storage part 280. That is to say, the design information relation acquisition part 114 grasps what piece of reference design information is used in which part of the development design information, and writes it in the related information storage part 280.

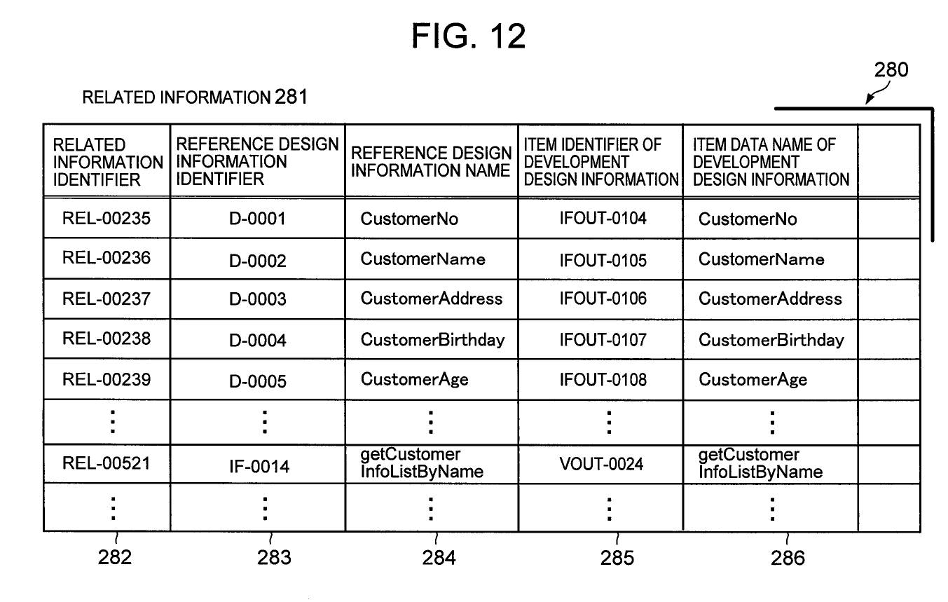

As shown in FIG. 12, related information 281 written in the related information storage part 280 includes: a related information identifier 282; an item identifier 285 of the object development design information; a data name 286 of the item in question; an identifier 283 of reference design information referred to by the item in question; and the name 284 of that reference design information.

For example, among the related information 281 of FIG. 12, a piece of related information 281 having the related information identifier 282 “REL-00235” in the top record shows that the item specified by the interface output item identifier “IFOUT-0104 (Item identifier 285)” and the interface information item name “CustomerNo (Item data name 286)” in the development design information 220 of FIG. 8 uses a piece of reference design information specified by the reference design information identifier 212 “REF-000001 (282)”, the data item identifier “D-0001 (283)” and the data item name “CustomerNo (284)” among the reference design information 210 of FIG. 7.

The step 13 is a process in which the intra-information reference consistency verification part 118b verifies whether the reference design information in the development design information is consistent with the referred design information. That is to say, here, it is verified whether the reference design information in the development design information saved in the step 11 has been changed while the development design information is being edited and whether the development design information is consistent with the new reference design information. The intra-information reference consistency verification part 118b refers to the related information 281 written in the related information storage part 280 in the step 12 and acquires the reference design information indicated by the related information 281 from the developer design information storage part 202. Then, the intra-information reference consistency verification part 118b compares the acquired reference design information with the item data (reference design information) in the development design information indicated by the related information 281, to verify the consistency between them.

The step 14 is a process in which the intra-information reference consistency verification part 118b records the state of intra-information consistency verified in the step 13 in the consistency state storage part 203.

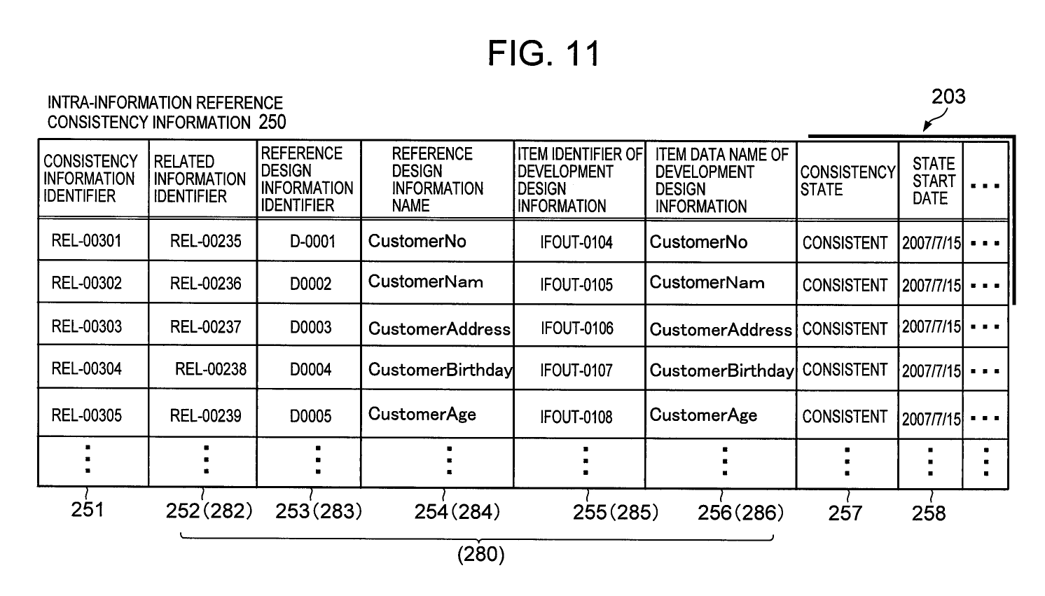

As shown in FIG. 11, the intra-information reference consistency information 250 recorded in the consistency state storage part 203 includes: a consistency information identifier 251; a related information identifier 252; a reference design information identifier 253; a reference design information name 254; an item identifier 255 of development design information; an item data name 256 of the development design information; a consistency state 257; and a state start date 258 on which the consistency state in question started. Among these pieces of data, the related information identifier 252, the reference design information identifier 253, the reference design information name 254 and the development design information item identifier 255 are respectively same as the corresponding pieces of data of the corresponding related information 281.

With that, the processing in response to the request for saving the development design information is ended, and the flow returns to the step 1.

As described above, if it is judged in the step 10 that the request from the developer or the manager is not a request for saving development design information, the flow proceeds to the step 15.

The step 15 is a process in which the request input part 111 judges whether the request from the developer or the manager is a request for publishing development design information. If it is a request for publishing development design information, the flow proceeds to the step 16. Otherwise, the flow proceeds to the step 23 (FIG. 18).

The steps 16-22 described in the following are processes responding to the request for publishing development design information.

The step 16 is a process of verifying the storage reference consistency information 240 and intra-information reference consistency information 250 relating to the development design information in question.

The storage reference consistency verification part 118a refers to the related information 281 stored in the related information storage part 280 and acquires the identifier of the reference design information used for the development design information whose publication is requested by the developer in order to confirm the storage reference consistency information 240 of the reference design information having that identifier. For example, in the case where the object of the publication request is the interface definition “getCustomerInfoListByName” shown in FIG. 8, the storage reference consistency verification part 118a refers to the related information 281 (FIG. 12) stored in the related information storage part 280 and acquires the reference design information identifiers “D-0001”, “D-0002”, . . . corresponding to the item identifiers “IFOUT-0104”, “IFOUT-0105”, . . . of the development design information “getCustomerInfoListByName” in question, in order to verify all pieces of storage reference consistency information 240 (FIG. 9) corresponding to these identifiers “D-0001”, “D-0002”, . . . . In this case, it is verified whether all consistency states 245 of all pieces of storage reference consistency information 240 whose acquirer identifier is “satoh” in FIG. 9 are “consistent”. If all consistency states 245 are “consistent”, it is judged that the storage reference consistency state of the development design information “getCustomerInfoListByName” is “consistent”.

The intra-information reference consistency verification part 118b acquires identifiers (i.e. item identifiers) of the reference design information used for the development design information whose publication is requested by the developer, from the development design information in question, and verifies the intra-information reference consistency information 250 of the reference design information of these identifiers. For example, the intra-information reference consistency verification part 118b acquires the item identifiers “IFOUT-0104”, “IFOUT-0105”, . . . of the development design information “getCustomerInfoListByName”, and verifies all pieces of intra-information reference consistency information 250 (FIG. 11) of these identifiers “IFOUT-0104”, “IFOUT-0105”, . . . . In this case, it is verified whether all consistency states 257 of all pieces of intra-information reference consistency information 250 are “consistent”. If all consistency states 257 are “consistent”, it is judged that the intra-information reference consistency state of the development design information “getCustomerInfoListByName” is “consistent”.

If all pieces of storage reference consistency information 240 corresponding to the development design information indicate “consistent” and all pieces of intra-information reference consistency information indicate “consistent”, then the flow proceeds to publication processing in the step 17. Otherwise, publication of the development design information in question is rejected.

The step 17 is a process in which the design information publication part 116 publishes the development design information, or in other words stores the development design information in question as public design information into the public design information storage part 260. For example, as shown in FIG. 24, the development design information “getCustomerInfoListByName” is stored as public design information 216b into the public design information storage part 260.

The step 18 is a process in which the status management part 117 updates the status of the development design information. The design information publication part 116 writes in the design information status storage part 270 to the effect that the development design information is stored as public design information in the public design information storage part 260 and as a result the public design information is in the check-in state.

The step 19 is a process in which, as shown in FIG. 24, the storage reference consistency verification part 118a verifies the storage reference consistency state between the public design information in question and other developers' reference design information for which the public design information in question is the referred information. This process reveals whether other developers' development design information referring to the published design information refers to the old information or not. As a result, in the case where a developer referring to the published design information does not update the design information in question for a given period of time for example, it is possible to help the developer even if the development design information of the developer has not been published.

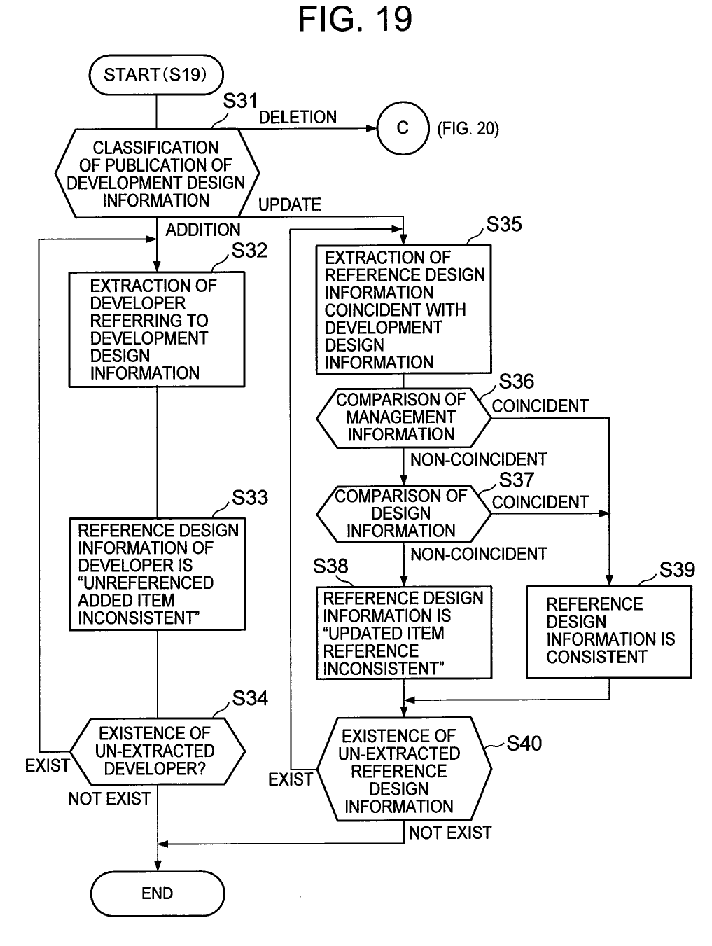

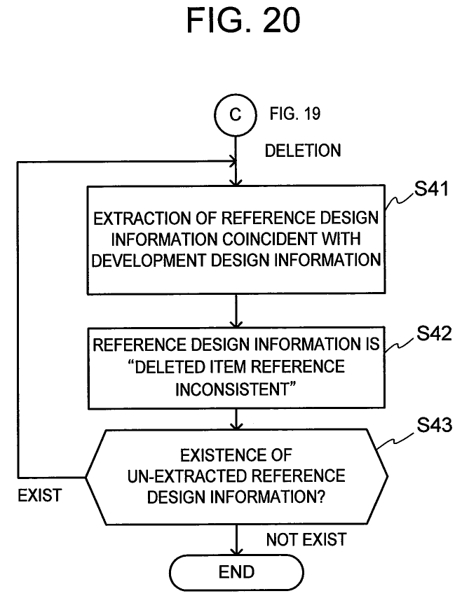

Now, the processing by the storage reference consistency verification part 118a in the step 19 will be described in detail by using the flowcharts shown in FIGS. 19 and 20.

The step 31 is a process of verifying a classification of publication of the published development design information. If the publication classification is addition of the development design information, the flow proceeds to the step 32. Or, if the publication classification is update of the development design information, the flow proceeds to the step 35. And, if the publication classification is deletion of the development design information, the flow proceeds to the step 41 (FIG. 20). Here, as shown in FIG. 4, the storage reference consistency verification part 118a verifies which of addition, update and deletion the publication classification is by comparing the public design information before change and the changed public design information.

The step 32 is a process of extracting a developer referring to the development design information whose publication classification is addition. The storage reference consistency verification part 118a refers to the developer information 230 (FIG. 6) to extract a developer identifier 231 for which the reference process classification 234 indicates the process classification of developing the development design information in question.

The step 33 is a process of determining that the reference design information of the developer extracted in the step 32 is “unreferenced added item inconsistent”. The developer referring to the development design information whose publication classification is “addition” has not yet acquired the development design information in question. Forgetting of acquisition causes omission of design/development concerning newly-published or -added development design information. Thus, it is determined that the design information in question is “unreferenced added item inconsistent”.

For example, in the case where the developer “yamada” of the data item acquires a list of public design information of the data items, adds a data item “ItemPrice” as shown in the changed list of public design information as shown in FIG. 4, and publishes this, the process of developing the public design information in question is “data item definition”. Thus, the storage reference consistency verification part 118a refers to the developer information 230 (FIG. 6) in the above-described step 32 and extracts a developer identifier 231 for which the reference process classification 234 is “data item definition”. For example, in FIG. 6, the developer “satoh” is extracted. Then, it is determined that the developer “satoh” is “unreferenced added item inconsistent” with respect to the data item “ItemPrice”.

The step 34 is a process of judging whether there is a developer who has not been extracted yet by the extraction process of the step 32. If there is a developer who has not been extracted yet, the flow returns to the step 32 to extract a developer. Otherwise, the processing is ended.

As described above, if it is judged in the step 31 that the publication classification of the development design information is “update”, the flow proceeds to the step 35.

The step 35 is a process of extracting reference design information whose identifier coincides with that of the development design information in question out of the list of reference design information. The storage reference consistency verification part 118a acquires the list of reference design information from the developer design information storage part 202, and extracts reference design information whose identifier coincides with that of the published development design information in question.

The step 36 is a process of judging whether the management information of the published development design information coincides with that of the extracted reference design information. If both pieces of management information coincide with each other, the flow proceeds to the step 39. Otherwise, the flow proceeds to the step 37.

The step 37 is a process of judging whether the development design main body information of the published development design information coincides with that of the extracted reference design information. If corresponding pieces of item data of both pieces of design main body information coincide with each other, the flow proceeds to the step 39. If data of any item of both pieces of design main body information do not coincide, the flow proceeds to the step 38.

The step 38 is a process of determining that the reference design information of the developer extracted in the step 35 is “updated item reference inconsistent”. Further, the step 39 is a process of determining that the reference design information of the developer extracted in the step 35 is “consistent”. When the processing of the step 38 or 39 is ended, the flow proceeds to the step 40.

For example, it is assumed that the data item developer “yamada” acquires the list of public design information before change shown in FIG. 4, updates the data item “CustomerNo” in the list into “CustomerID” as shown in the changed list of public design information shown in the same figure, and publishes the changed list as public design information. The storage reference consistency verification 118a acquires the data item identifier “D-001” of this data item “CustomerID”, and in the step 36 compares the update count “2” at the time of acquisition of this data item identifier in the reference design information 210 shown in FIG. 7 with the update count “3” of the data item identifier “D-001” in the list of changed public design information shown in FIG. 4. In this example, since the update counts are different from each other, the development design main body information “CustomerID” is compared in the step 37 with the reference design main body information “CustomerNo”. Here, since both pieces of design main body information do not coincide, it is determined in the step 38 that the reference design information in question is “updated item reference inconsistent”.

The step 40 is a process of judging whether there is reference design information that has not been extracted yet. If there is reference design information that has not been extracted, the flow returns to the step 35 to extract reference design information further more. If there is not reference design information that has not been extracted yet, the processing is ended.

As described above, if it is judged in the step 31 that the publication classification of the development design information is “deletion”, the flow proceeds to the step 41 (FIG. 20).

The step 41 is a process of extracting reference design information that coincides with the development design information in question out of the list of reference design information. The storage reference consistency verification part 118a acquires the list of reference design information from the developer design information storage part 202, and extracts reference design information whose identifier coincides with that of the development design information whose deletion has been published.

The step 42 is a process of determining that the reference design information in question is “deleted item reference inconsistent”. If a developer continues to refer to deleted public design information, it is possible that the deleted information is erroneously embedded in development design information, causing reduction in quality of the design. Thus, it is determined that the reference design information in question is “deleted item reference inconsistent”.

The step 43 is a process of judging whether there is reference design information that has not been extracted yet. If there is reference design information that has not been extracted yet, the flow returns to the step 41 to extract reference design information furthermore. If there is not reference design information that has not been extracted, the processing is ended.

For example, it is assumed that the data item developer “yamada” acquires the list of public design information before change shown in FIG. 4, deletes “CustomerAge” in the list as shown in the changed list of public design information shown in the same figure, and publishes it. Here, deletion means that the public design information deleted by the developer never could be acquired by others, not that the public design information in question itself is deleted from the list of public design information. The storage reference consistency verification part 118a acquires the data item identifier “D-006” of this data item “CustomerAge”, extracts reference design information (FIG. 7) of the data item identifier “D-006”, and determines that the reference design information is “deleted item reference inconsistent”.

Thus, the processes of the steps 31-43 bring an end to the processing (the step 19) of verifying consistency with stored reference design information of the other developers in the flowchart of FIG. 17, and the flow proceeds to the step 20. In the above, a detailed description of an example of storage reference consistency verification (S19) has been given as for the case where the data item developer “yamada” publishes the data item “CustomerNo” and the like as development design information, while FIG. 24 shows an example of storage reference consistency verification (S19) in the case where the interface developer “satoh” publishes the interface “getCustomerInfoListByName” as development design information.

The step 20 is a process in which the storage reference consistency verification part 118a updates the storage reference consistency information 240 in the consistency state storage part 203 on the basis of the verification result of the consistency verification processing of the step 19.

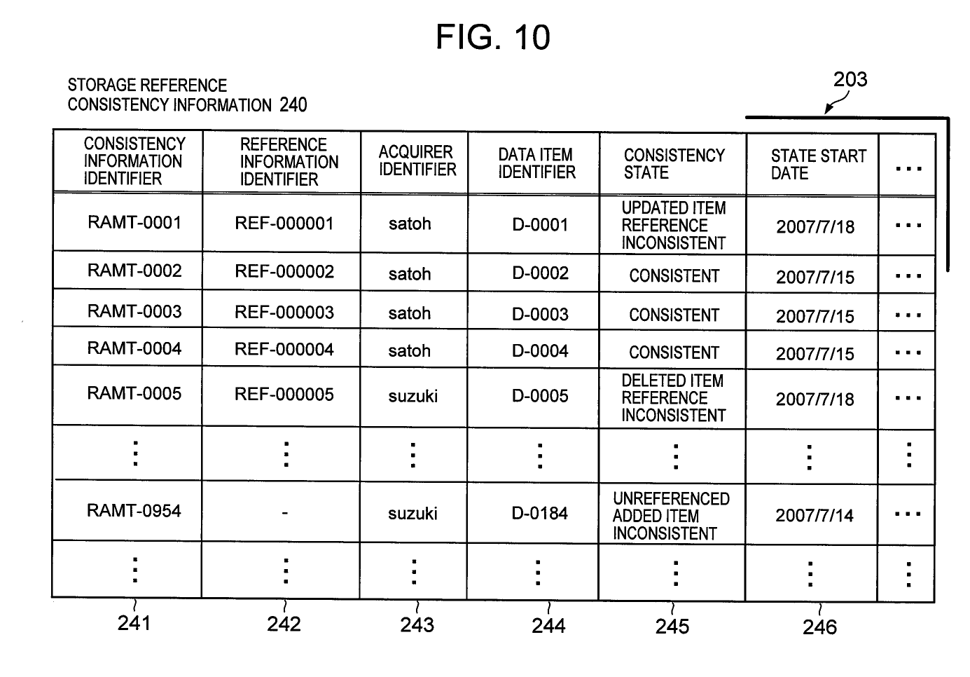

As described above referring to FIG. 4, it is assumed that the data item developer “yamada” updates the data item “CustomerNo” (the data item identifier “D-0001”) as one piece of public design information among the list of public design information into “CustomerID”, deletes the data item “CustomerAge” (the data item identifier “D-0005”) as another piece of public design information, adds the data item “ItemPrice” (the data item identifier “D-0184”) as still another piece of public design information, and publishes these. In this case, in the consistency state storage part 203, the storage reference consistency information 240 concerning the developer “satoh” who refers to the list of public design information is changed from the contents of FIG. 9 to the contents of FIG. 10. That is to say, the consistency state 245 of the data item “CustomerNo” (the data item identifier “D-0001”) as reference design information is changed to “updated item reference inconsistent”, the consistency state 245 of the data item “CustomerAge” (the data item identifier “D-0005”) as reference design information to “deleted item reference inconsistent”, and the consistency state 245 of the data item “ItemPrice” (the data item identifier “D-0184”) as reference design information to “unreferenced added item inconsistent”.

As shown in FIG. 24, the step 21 is a process in which the intra-information reference consistency verification part 118b verifies intra-information reference consistency with public design information of the other developers. First, the intra-information reference consistency verification part 118b extracts related information 281 whose reference design information identifier 283 is the identifier of the newly-published development design information from the related information storage part 280 (FIG. 12). Then, the intra-information reference consistency verification part 118b extracts public design information that includes the item data of the development design information item identifier 285 of the related information 281 in question, and verifies intra-information reference consistency between the item data (reference design information) in the public design information in question and the newly-published development design information.

For example, it is assumed that the interface developer “satoh” has published the interface “getCustomerInfoListByName” (the identifier “IF-0014”) as development design information. In this case, the intra-information reference consistency verification part 118b first extracts related information 281 whose reference design information identifier 283 is the identifier “IF-0014” of the newly-published development design information from the related information storage par 280 (FIG. 12). Then, as shown in FIG. 24, the intra-information reference consistency verification part 118b extracts public design information (the identifier “V-0011”) that includes the item data “getCustomerInfoListByName” of the item identifier “VOUT-0024” 285 of the development design information in the related information 281 in question, and verifies intra-information reference consistency between the item data (reference design information) in the extracted public design information and the newly-published development design information.

The step 22 is a process in which the intra-information reference consistency verification part 118b updates the intra-information reference consistency information 250 in the consistency state storage part 203 on the basis of the verification result of the consistency verification processing of the step 21.

Thus, the processes of the steps 15-22 bring an end to the processing in response to the request for publication of development design information, and the flow returns to the step 1.

As described above, if it is judged in the step 15 (FIG. 17) that the request from the developer or the manager is not a request for publishing development design information, the flow proceeds to the step 23 (FIG. 18).

The step 23 is a process in which the request input part 111 judges whether the request from the developer or the manager is a report request or not. If the request is a report request, the flow proceeds to the step 24. Otherwise, the flow returns to the step 1. The steps 24-26 described in the following are processes responding to the report request.

The step 24 is a process in which the request input part 111 judges the classification of the report requester. If the report requester is the manager, the flow proceeds to the step 25. If the requester is a developer, the flow proceeds to the step 26.

The step 25 is a process of providing a development status report. The development status generation part 119a generates a development status information, writes the generated development status information into a development status storage part 130, and calls the development status notification part 119b. The development status notification part 119b acquires the development status information generated by the development status generation part 119a from the development status storage part 130, and notifies the acquired development status information to the manager as the requester. Here, the development status generation part 119a generates development status information when a request for a development status occurs. However, it is possible that the development status generation part 119a generates development status information periodically.

The development status information includes: reference consistency information classified by developer, which is obtained by aggregating the storage reference consistency information 240 for each developer; reference consistency information classified by development process, which is obtained by aggregating the storage reference consistency information 240 for each development process; and estimated progress status information classified by development process. These kinds of consistency information are each given in a table form. The development status notification part 119b may notify the manager of only one kind of information that has been requested by the manager among these three kinds of information, or may notify the manager of all three kinds of information.

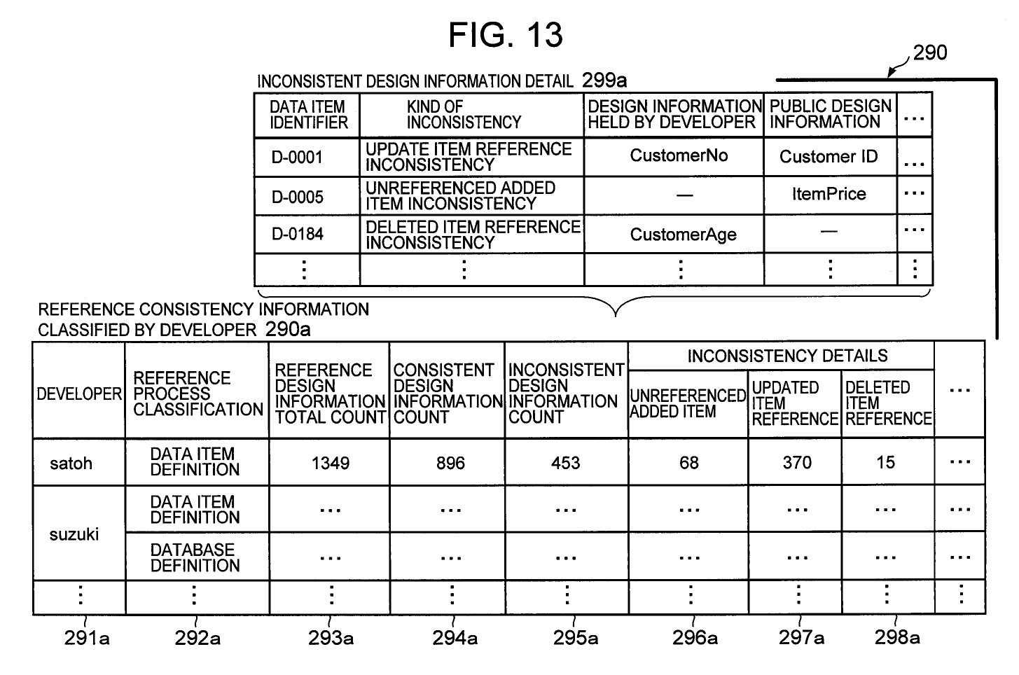

As shown in FIG. 13, the table showing the reference consistency information classified by developer 290a has: a developer identifier field 291a for storing a developer identifier; a reference process classification field 292a for storing a reference process classification of the developer; a reference design information total count field 293a for storing the total number of reference design information for each reference process classification; a consistent design information count field 294a for storing the number of consistent reference design information among the reference design information; an inconsistent design information count field 295a for storing the number of inconsistent reference design information among the reference design information; and an inconsistency details field for storing details of the inconsistent reference design information. The inconsistency details field has: an unreferenced added item inconsistency field 296a for storing the number of unreferenced added item inconsistencies; an updated item reference inconsistency field 297a for storing the number of updated item reference inconsistencies; and a deleted item reference inconsistency field 298a for storing the number of deleted item reference inconsistencies.

In addition to the above fields, the reference consistency information classified by developer 290a has an inconsistent design information detail 299a for showing explicitly a kind of inconsistency for each piece of design information, and other data.

The development status generation part 119a generates the reference consistency information classified by developer 290a by referring to the storage reference consistency information 240 (FIG. 10) stored in the consistency state storage part 203 and the developer information 230 (FIG. 6) stored in the developer design information storage part 202. As described above, the development status notification part 119b acquires the reference consistency state information classified by developer 290a generated by the development status generation part 119a from the development status storage part 130, and notifies the acquired information to the manager as the requester.

The manager grasps developers who are in a reference inconsistent state on the basis of the reference consistency state information classified by developer 290a, and urges those developers to acquire the newest information. When the manager wishes to know the inconsistent reference design information in detail, the manager requests the inconsistent design information detail 299a and inspects it.

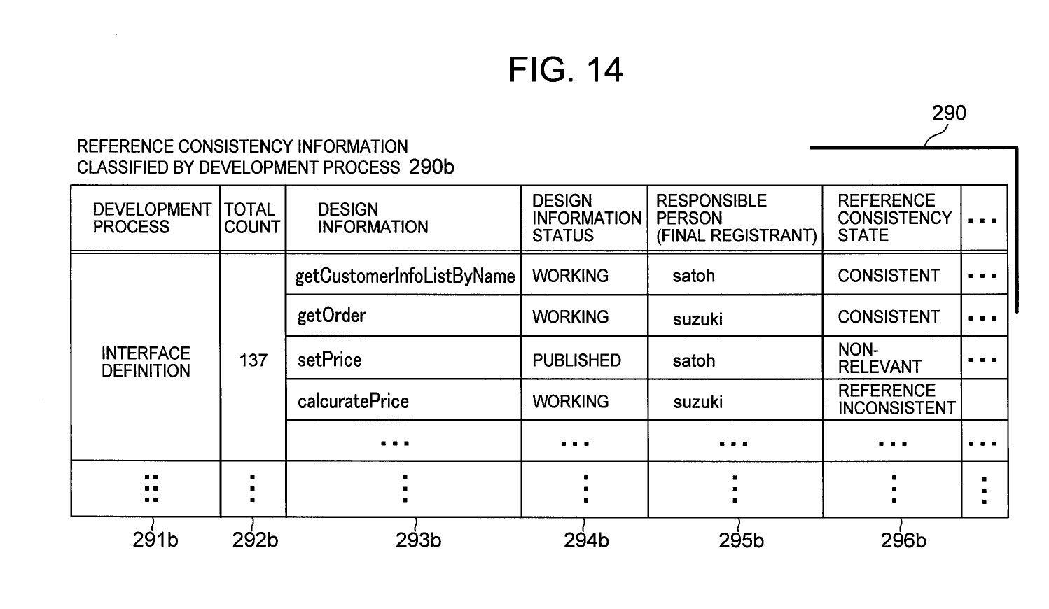

As shown in FIG. 14, the table showing the reference consistency information classified by development process 290b has: a development process name field 291b for storing a development process name; a total count field 292b for storing the total number of all pieces of design information under the development process; a design information status field 294b for storing a status of each piece of design information; a responsible person field 295b for storing a name of person (final registrant) in charge of development of each piece of design information; and a reference consistency state field 296b for storing a storage reference consistency state of each piece of design information.

The development status generation part 119a generates the reference consistency information classified by development process 290b by referring to the statuses stored in the design information status storage part 270 as well as the storage reference consistency information 240 (FIG. 10) stored in the consistency state storage part 203 and the developer information 230 (FIG. 6) stored in the developer design information storage part 202 used for generating the above-mentioned reference consistency information classified by developer 290a.

As described referring to FIG. 23, a status stored in the design information status storage part 270 is either check-in or check-out. However, the design information status field 294b stores “published” meaning check-in or “working” meaning check-out, instead of check-in or check-out.

As described above, the development status notification part 119b acquires the reference consistency information classified by development process 290b generated by the development status generation part 119a from the development status storage part 130, and notifies the acquired information to the manager as the requester.

Based on the reference consistency information classified by development process 290b, the manager can know whether each piece of design information is under working or has been published and who is the developer in charge, and whether the reference design information of the developer is consistent if under working.

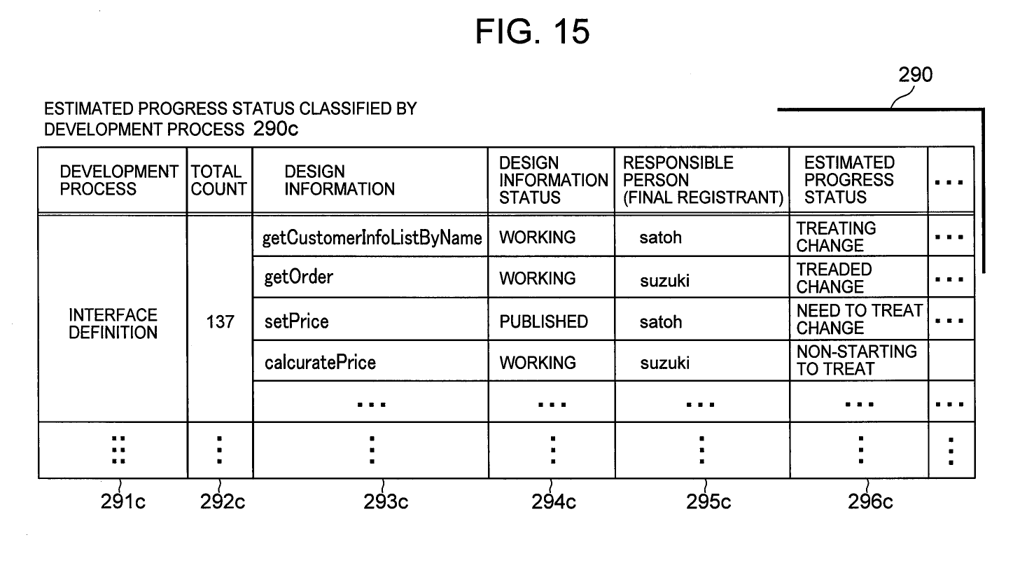

As shown in FIG. 15, the table showing the estimated progress status classified by development process 290c has: a development process name field 291c for storing a name of a development process; a total count field 292c for storing the total number of all pieces of design information in the development process; a design information name field 293c for storing a name of each piece of design information in the development process; a design information status field 294c for storing a status of each piece of design information; a responsible person field 295c for storing a name of person (final registrant) in charge of development of each piece of design information; and an estimated progress status field 296c for storing an estimated progress status of each piece of design information. That is to say, this table showing the estimated progress status classified by development process 290c is obtained by replacing the reference consistency state field 296b in the above-described table showing the reference consistency information 290b classified by development process described by using FIG. 14 with the estimated progress status field 296c.

Thus, in generating the estimated progress status classified by development process 290c, the development status generation part 119a refers also to the intra-information reference consistency information 250 (FIG. 11) for acquiring the estimated progress statuses, while referring to the storage reference consistency information 240 (FIG. 10), the developer information 230 (FIG. 6) and the statuses stored in the design information status storage part 270 used for generating the above-described reference consistency information classified by development process 290b.

The estimated progress status field 296c stores “treating change”, “treated change”, “need to treat change”, “non-starting to treat change”, or the like. Since the estimated progress status of each piece of design information is notified to the manager, the manager can grasp the progress status of the development more accurately.

Here, a method of obtaining an estimated progress status of each piece of design information will be described.

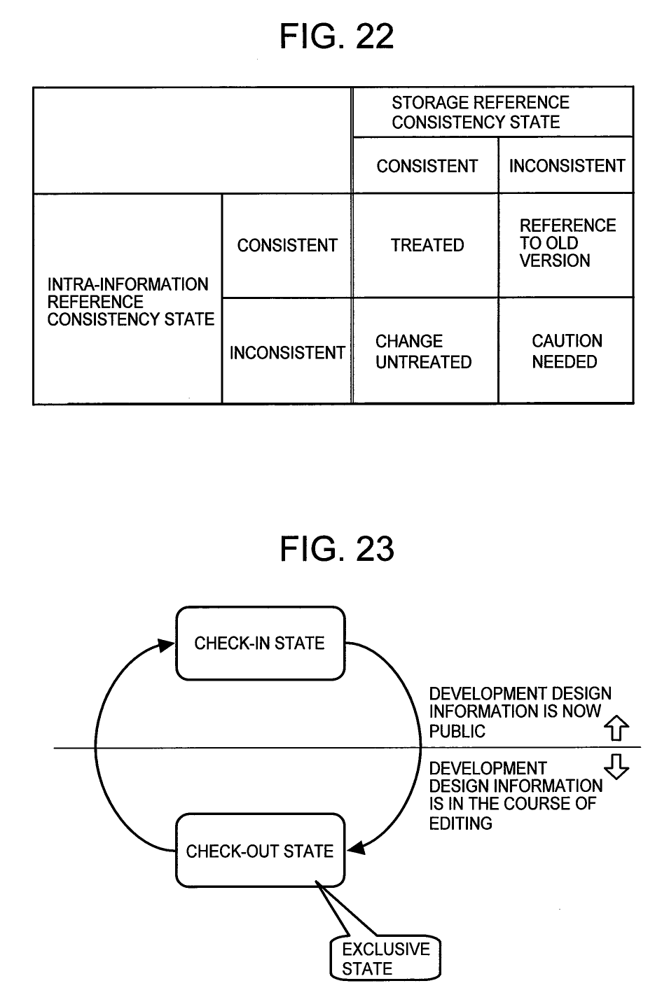

First, the development status generation part 119a acquires the storage reference consistency information 240 (FIG. 10) and the intra-information reference consistency information 250 (FIG. 11) for each piece of design information. Next, referring to the treatment status setting rule shown in FIG. 22, the development status generation part 119a determines the treatment status corresponding to the storage reference consistency state and the intra-information reference consistency state concerning the reference design information used for design information. According to this treatment status setting rule, the status is determined as “treated” with respect to the change in the reference design information, when both the storage reference consistency state and the intra-information reference consistency state are “consistent”. When the storage reference consistency state is “consistent” while the intra-information reference consistency information is “inconsistent”, the status is determined as “reference to old version” with respect to the change in the reference design information, since the developer design information 220 in the developer design information storage part 202 is not using the new reference design information although the reference design information 210 stored in the developer design information storage part 202 has been updated to the new reference design information. Further, when the storage reference consistency state is “inconsistent”, the status is determined fundamentally as “change untreated” with respect to change in the reference design information. However, when the intra-information reference consistency state also is “inconsistent”, the status is determined as “caution needed”.

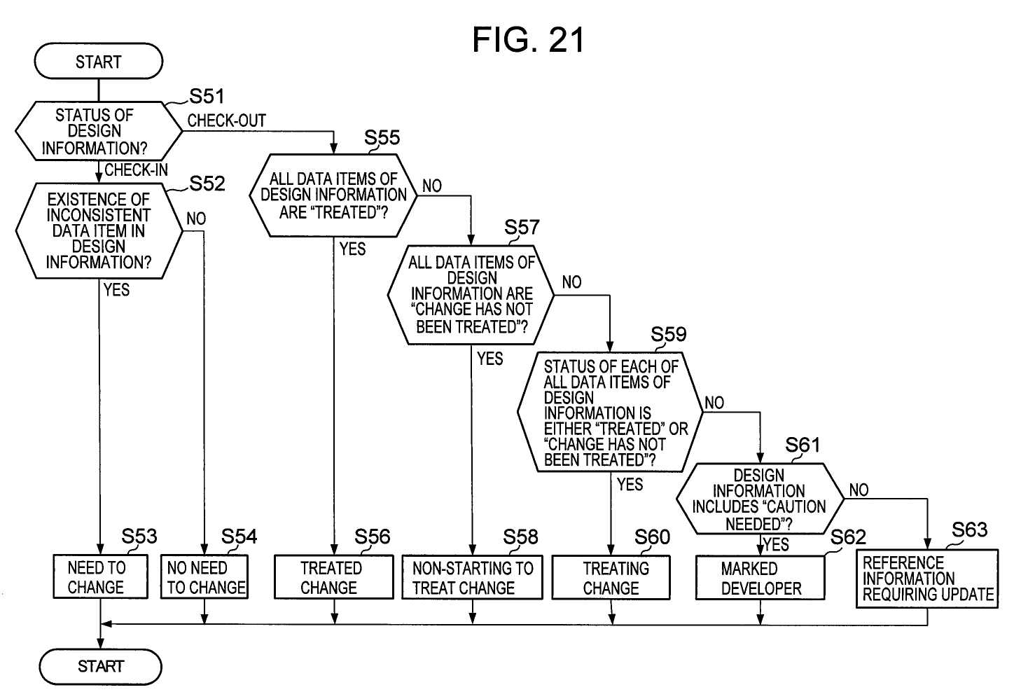

When the development status generation part 119a acquires the treatment status for each item data (reference design information) in each piece of design information, then the development status generation part 119a acquires the estimated progress status of each piece of design information according to the flowchart shown in FIG. 21.

In detail, the development status generation part 119a examines the status concerning the design information in question (S51). If the status of the design information is “check-in”, the flow proceeds to the step 52. Or, if the status of the design information is “check-out”, the flow proceeds to the step 55. In the step 52, it is judged whether an inconsistent data item exists among the data items in the design information. If there is an inconsistent data item, the estimated progress status is determined as “need to change” in the step 53 to indicate that change is needed with respect to the design information. Further, if there is no inconsistent data item, the estimated progress status is determined as “no need to change” in the step 54 to indicate that change is not necessary with respect to the design information.

In the case where the status of the design information is judged in the step 51 to be “check-out” and the flow proceeds to the step 55, it is judged whether all data items of the design information have been already “treated”. If all data items of the design information have been already “treated”, the status is determined as “treated change” in the step 56 to indicate change has been treated with respect to the design information. Further, if not all data items of the design information have been already “treated”, the flow proceeds to the step 57.

In the step 57, it is judged whether the status is “change has not been treated” with respect to all data items of the design information. If the status is “change has not been treated” with respect to all data items, the status is determined as “non-starting to treat change” in the step 58 to indicate that treatment of change concerning the design information in question has not been started. If it is not true that the status is “change has not been treated” with respect to all data items of the design information, the flow proceeds to the step 59.

In the step 59, it is judged whether, for each of all data items of the design information, the status is either “treated” or “change has not been treated”. If the status of each data item is either “treated” or “change has not been treated”, the status is determined as “treating change” in the step 60. If it is not true that each data item is either “treated” or “change has not been treated”, the flow proceeds to the step 61.

In the step 61, it is judged whether there is a data item in the status “caution needed” among all data items of the design information. If there is a data item in the status “caution needed”, the estimated progress status is determined as “marked developer” in the step 62 to indicate that attention should be paid to this developer since the developer has not made any change. If no data item is in the status “caution needed”, the estimated progress status is determined as “reference information requiring update” in the step 63 considering that the design information in question includes the status “reference to old version”.

The development status generation part 119a stores the result of status judgment of the step 53, 54, 56, 58, 60, 62 or 63 into the estimated progress status field 296c of the estimated progress status classified by development process 290c.

With that, the processing of obtaining the estimated progress status of each piece of design information is ended.

Here, the estimated progress status is obtained for each development process. However, it is possible to obtain an estimated progress status for each developer, and provide it to the manager.

As described above, if it is judged in the step 24 (FIG. 18) that the report requester is a developer, the flow proceeds to the step 26.

The step 26 is a process of providing a consistency state report concerning all pieces of design information included in the process in charge of the developer who has made the report request. The consistency state report is generated by the development status generation part 119a and notified by the development status notification part 117 to the developer as the requester.

This consistency state report indicates the storage reference consistency state and the intra-information reference consistency state with respect to all pieces of design information included in the process in charge of the developer who has made the report request, by referring to the storage reference consistency information 240 and the intra-information reference consistency information 250.

As a method of displaying the consistency state report, it is possible to consider, for example: (1) a method of using a dialogue to display occurrence of inconsistency on a screen; (2) a method of displaying on a screen a list of design information in which inconsistency exists; (3) a method of displaying design information in which inconsistency exists in a different color on a design screen; and (4) a method of adding hyperlink or a button to design information in which inconsistency exists on a design screen, where for example a click of information causes displaying of detailed contents of the inconsistency or candidates for change.

Thus, the processes of the steps 23-26 bring an end to the processing of the report request, and the flow returns to the step 1.

Thus, the present embodiment can reveal possibility that inconsistency between already-published deriverables may cause problems, when a software developer is preparing design without referring to the newest deriverables in the stage before publishing design information to the public design information storage part 260, and can notify it to the developer and other persons. Further, according to the present embodiment, it is possible to detect reference inconsistency for each data item in development information of a developer, and reject inappropriate publishing of the design information caused by developer's alteration or forgetting of update. As a result, the embodiment of the present invention can reduce waste owing to redesign of design information or the like, and promote the efficiency of development.

Further, according to the embodiment of the present invention, it is also possible to notify the manager of progress information that indicates how many developers have acquired and dealt with newly-published or -corrected design information. Thus, the manager can easily perform process management of the software development.

While we have shown and described several embodiments in accordance with out invention, it should be understood that the disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A software development support apparatus for supporting development of software formed by collecting pieces of design information of respective design units, comprising:
a public design information storage area for storing pieces of public design information;
a design information publication part that stores, as the public design information, design information designed by a developer into the public design information storage area;
a design information output part that acquires the public design information to be used by a developer for designing design information from the public design information storage area, and provides the acquired public design information as reference design information to the developer;
a reference design information storage area that stores pieces of reference design information;
a reference design information storage part that stores, as the reference design information, pieces of public design information used by a developer for designing design information among the pieces of public design information into the reference design information storage area;
a reference consistency verification part that verifies a consistency state between the public design information and reference design information referring to the public design information among the pieces of reference design information stored in the reference design information storage area, when the design information publication part stores the public design information into the public design information storage area;
a consistency state storage area into which the reference consistency verification part stores, as a first consistency state, the consistency state verified by the reference consistency verification part; and
a development status notification part that notifies the consistency state stored in the consistency state storage area to an outside.

2. A software development support apparatus of claim 1, wherein:
the software development support apparatus further comprises:
a development design information storage area for storing development design information; and
a design information input part that receives design information being designed by a developer, and stores, as the development design information, the received design information into the development design information storage area; and
when the design information input part stores the development design information into the development design information storage area, the reference consistency verification part verifies a consistency state between reference design information in the development design information and reference design information of the development design information among the pieces of reference design information stored in the reference design information storage area, and stores, as a second consistency state, the verified consistency state into the consistency state storage area.

3. A software development support apparatus of claim 2, wherein:
the software development support apparatus further comprises a design information relation acquisition part and a relation information storage area:
when the design information input part stores the development design information into the development design information storage area, the design information relation acquisition part compares pieces of item data constituting the development design information with reference design information of the development design information among the pieces of reference design information stored in the reference design information storage area, grasps which pieces of item data uses the reference design information among the pieces of item data in the development design information, and acquires relation between item data using the reference design information and the reference design information;
the relation information storage area stores information of the relation acquired by the design information relation acquisition part; and
when the design information input part stores the development design information into the development design information storage area, the reference consistency verification part refers to the information of the relation stored in the relation information storage area, in order to verify a consistency state between item data using reference design information in the development design information and the reference design information of the development design information among the pieces of reference design information stored in the reference design information storage area.

4. A software development support apparatus of claim 2, wherein:
when the reference consistency verification part receives a request for publishing the development design information stored in the development design information storage area, the reference consistency verification part verifies the first consistency state of the reference design information and the second consistency state of the development design information by referring to the consistency state storage area, and judges both consistency states show consistency; and
when the reference consistency verification part judges, with respect to the development design information whose publication has been requested, that the first consistency state and the second consistency state are both consistent, then the design information publication part stores, as the public design information, the development design information in the development design storage area into the public design information storage area.

5. A software development support apparatus of claim 2, wherein:
when the design information publication part stores, as new public design information, the development design information into the public design information storage area, then the reference consistency verification part verifies a consistency state between the new public design information and reference design information in public design information whose reference design information is the new public design information, and stores, as the second consistency state, the verified consistency state into the consistency state storage area.

6. A software development support apparatus of claim 2, wherein:
the software development support apparatus further comprises a development status generation part that determines a treatment status according to a combination of consistency or inconsistency shown by the first consistency state and consistency or inconsistency shown by the second consistency state at a time of change of public design information referred to by design information changes, by using a previously-determined rule and the first and second consistency states (stored in the consistency storage area) of the design information, and generates development status information of the design information by using the determined treatment status; and
the development status notification part notifies the development status information to an outside.

7. A software development support apparatus of claim 1, wherein:
the software development support apparatus further comprises a development status generation part that generates reference consistency information classified by developer with respect to each developer in charge of a previously-determined process and/or reference consistency information classified by process with respect to each process;
for generating the reference consistency information classified by developer, the development status generation part refers to the consistency state storage area in order to aggregate, for each developer, a number of consistencies or inconsistencies indicated by the first consistency state with respect to one or more pieces of design information in a process in charge of the developer in question to obtain the number of consistencies and the number of inconsistencies in the process, and defines the number of the consistencies and the number of the inconsistencies in the process as the reference consistency information classified by developer with respect to the developer in charge of the process;
for generating the reference consistency information by process, the development status generation part acquires, for each process, the first consistency state of each of one or more pieces of design information in the process, and defines information obtained by relating a piece of design information with the first consistency state for each of one or more pieces of design information in the process as the reference design information by process; and
the development status notification part notifies the reference consistency information by developer and/or the reference consistency information by process to an outside.

8. A software development support program that is formed by collecting pieces of design information of each design unit, wherein:
the software development support program makes a computer execute:
a design information publication step, in which pieces of design information developed by a developer are stored as respective pieces of public design information into a first storage area of the computer;
a design information output step, in which the public design information used by a developer for designing design information is acquired from the first storage area, and the acquired public design information is provided as reference design information to the developer;
a reference design information storage step, in which pieces of public design information used by a developer for designing design information among the pieces of public design information are stored as reference design information into a second storage area of the computer;
a reference consistency verification step, in which when the public design information is stored in the first storage area in the design information publication step, a consistency state between the public design information and reference design information referring to the public design information among the pieces of reference design information stored in the second storage area, and the verified consistency state is stores as a first consistency state into a third storage area of the computer; and
a development status notification step, in which development status information including information of the consistency state stored in the third storage area is notified to an outside.

9. A software development support program of claim 8, wherein:
the software development support program makes the computer execute further a design information input step, in which design information that a developer is developing is received and stored as development design information into a fourth storage area of the computer; and
in the reference consistency verification step, when the development design information is stored in the fourth storage area in the design information input step, a consistency state between pieces of reference design information in the development design information and pieces of reference design information of the development design information among the pieces of reference design information stored in the second storage area is verified, and the verified consistency state is stored as a second consistency state into the third storage area.

10. A software development support program of claim 9, wherein:
in the reference consistency verification step, when a request for publication of the development design information stored in the fourth storage area is received, the third storage area is referred to in order to verify the first consistency state of the reference design information used for the development design information and the second consistency state of the development design information is verified, to judge whether each consistency state shows consistency;
in the design information publication step, when, with respect to the development design information whose publication has been requested, it is judged in the reference consistency verification step that each of the first consistency state and the second consistency state shows consistency, the development design information in the fourth storage area is stored as the public design information into the first storage area.

11. A method of supporting development of software that is formed by collecting pieces of design information for each design unit, wherein a computer executes:
a design information publication step, in which pieces of design information developed by a developer are stored as respective pieces of public design information into a first storage area of the computer;
a design information output step, in which the public design information used by a developer for designing design information is acquired from the first storage area, and the acquired public design information is provided as reference design information to the developer;
a reference design information storage step, in which pieces of public design information used by a developer for designing design information among the pieces of public design information are stored as reference design information into a second storage area of the computer;
a reference consistency verification step, in which when the public design information is stored in the first storage area in the design information publication step, a consistency state between the public design information and reference design information referring to the public design information among the pieces of reference design information stored in the second storage area, and the verified consistency state is stores as a first consistency state into a third storage area of the computer; and
a development status notification step, in which development status information including information of the consistency state stored in the third storage area is notified to an outside.
